(19) United States
(12) Patent Application Publication
(10) Pub. No.: US 2008/0281589 A1
(43) Pub. Date: Nov. 13, 2008

(54) Noise Suppression Device and Noise Suppression Method

(75) Inventors: Youhua Wang, Ishikawa (JP); Takuya Kawashima, Ishikawa (JP); Koji Yoshida, Kanagawa (JP)

Correspondence Address: DICKINSON WRIGHT PLLC, 1901 L STREET NW, SUITE 800, WASHINGTON, DC, 20036, US

(73) Assignee: MATSUSHITA ELECTRIC INDUSTRAIL CO., LTD., Osaka (JP)

(21) Appl. No.: 11/629,381

(22) PCT Filed: May 30, 2005
(86) PCT No.: PCT/JP05/09859

§ 371 Date: Dec. 13, 2006

(30) Foreign Application Priority Data
Jun. 18, 2004 (JP) 2004-181454

(51) Int. Cl. G10L 21/00

(52) U.S. Cl. 704/226; 704/E21.001

(57) ABSTRACT

There is disclosed a noise suppression device capable of improving the noise suppression accuracy while reducing the audio distortion. In this device, a suppression unit suppresses a noise component from the audio power spectrum by using the detection result of the audio-existing band and the noise band in the audio power spectrum including the noise component. A pitch harmonic structure extracting unit (105) extracts a pitch harmonic power spectrum from the audio power spectrum. An audio-existence judgment unit (106) judges whether the audio power spectrum has audio existence according to the extracted pitch harmonic power spectrum. A pitch harmonic structure repair unit (108) repairs the extracted pitch harmonic power spectrum. A per-band audio/noise correction unit (109) corrects the detection result according to the pitch harmonic power spectrum selected according to the result of judgment by the audio-existence judgment unit (106) among the repaired pitch harmonic power spectrum and the extracted pitch harmonic power spectrum.

### TECHNICAL FIELD

The present invention relates to a noise suppressing apparatus and noise suppressing method, and more particularly, to a noise suppressing apparatus and noise suppressing method that are used in a speech communication apparatus and speech recognition apparatus and suppress background noise.

### BACKGROUND ART

Generally, although a low-bit rate speech coding apparatus is able to provide a call of high-quality speech for speech without background noise, it causes annoying distortion unique to low-bit rate coding for speech containing background noise, and this may result in speech quality deterioration.

As noise suppressing/speech enhancing technique performed to cope with such speech quality deterioration, for example, a spectral subtraction method (hereinafter referred to as the “SS method”) is included.

In the SS method, characteristics of a noise component are estimated in inactive speech period. Then, by subtracting a short-time power spectrum of a noise component from a short-time power spectrum of a speech signal containing the noise component (hereinafter referred to as a “speech power spectrum”), or by multiplying the speech power spectrum by an attenuation coefficient, a speech power spectrum in which the noise component suppressed is generated (for example, see non-patent document 1).

Further, in the SS method, spectral characteristics of the estimated noise component are regarded as stationary, and are equally subtracted from the speech power spectrum as a nose base. However, the spectral characteristics of a noise component are not actually stationary, and by residual noise after the subtraction of the noise base, particularly, residual noise between speech pitches, unnatural distortion that is the so-called musical noise may be caused.

As a conventional noise suppressing method of suppressing the musical noise, for example, a method of performing multiplication using an attenuation coefficient based on a ratio between speech power and noise power (SNR) (for example, see patent document 1 and patent document 2) has been proposed. According to this method, a band with relatively high speech (band with a high SNR) and a band with relatively high noise (band with a low SNR) are distinguished from each other and different attenuation coefficients are used for them.

### Patent Document 1: Japanese Patent Publication No. 2714656

Patent Document 2: Japanese Patent Application Laid-Open No. HEI10-513030
Non-patent Document 1: “Suppression of acoustic noise in speech using spectral subtraction”, Boll, IEEE Trans. Acoustics, Speech, and Signal Processing, vol. ASSP-27, pp. 113-120, 1979

### DISCLOSURE OF INVENTION

### Problems to be Solved by the Invention

However, in the above-mentioned conventional noise suppressing method, although the speech band and the noise band are distinguished from each other using the SNR, it is not easy to accurately distinguish between the bands, particularly in a case where spectral characteristics of a noise component are not stationary. In other words, certain limitations exist in speech distortion reduction and accuracy in noise suppression.

The present invention is carried out in terms of the foregoing, and it is therefore an object of the present invention to provide a noise suppressing apparatus and noise suppressing method of reducing speech distortion and improving accuracy in noise suppression.

### Means for Solving the Problem

A noise suppressing apparatus of the present invention adopts a configuration having: a suppressing section that suppresses a noise component in a speech power spectrum using the detection result of an active speech band and a noise band in the speech power spectrum containing the noise component; an extracting section that extracts a pitch harmonic power spectrum from the speech power spectrum; a voicedness determination section that determines a voicedness of the speech power spectrum based on the extracted pitch harmonic power spectrum; a restoration section that restores the extracted pitch harmonic power spectrum; and a correcting section that corrects the detection result based on the pitch harmonic power spectrum selected from the restored pitch harmonic power spectrum and the extracted pitch harmonic power spectrum, according to the determination result by the voicedness determination section.

A noise suppressing method of the present invention is a noise suppressing method of suppressing a noise component in a speech power spectrum using the detection result of an active speech band and a noise band in the speech power spectrum containing the noise component, and has: an extracting step of extracting a pitch harmonic power spectrum from the speech power spectrum; a voicedness determining step of determining a voicedness of the speech power spectrum based on the extracted pitch harmonic power spectrum; a restoring step of restoring the extracted pitch harmonic power spectrum; and a correcting step of correcting the detection result based on the pitch harmonic power spectrum selected from the restored pitch harmonic power spectrum and the extracted pitch harmonic power spectrum, according to a result of determination in the voicedness determining step.

A noise suppressing program of the present invention is a noise suppressing program for suppressing a noise component in a speech power spectrum using the detection result of an active speech band and a noise band in the speech power spectrum containing the noise component, and allows a computer to implement: an extracting step of extracting a pitch harmonic power spectrum from the speech power spectrum; a voicedness determining step of determining a voicedness of the speech power spectrum; a restoring step of restoring the extracted pitch harmonic power spectrum; and a correcting step of correcting the detection result based on the pitch harmonic power spectrum selected from the restored pitch harmonic power spectrum and the extracted pitch harmonic power spectrum according to a result of determination in the voicedness determining step.

### ADVANTAGEOUS EFFECT OF THE INVENTION

According to the present invention, it is possible to reduce speech distortion and improve accuracy in noise suppression.

### BRIEF DESCRIPTION OF DRAWINGS

FIG. 1 is a block diagram illustrating a configuration of a noise suppressing apparatus according to Embodiment 1 of the present invention;

FIG. 2A is a graph showing a detection result of an active speech band and a noise band;

FIG. 2B is a graph showing an extraction result of a pitch harmonic power spectrum;

FIG. 2C is a graph showing an extraction result of peaks of the pitch harmonic;

FIG. 2D is a graph showing a restoration result of the pitch harmonic power spectrum;

FIG. 2E is a graph showing a correction result of the detection result of as shown in FIG. 2A;

FIG. 3 is a block diagram illustrating a configuration of a noise suppressing apparatus according to Embodiment 2 of the present invention;

FIG. 4 is a block diagram illustrating a configuration of a noise suppressing apparatus according to Embodiment 3 of the present invention;

FIG. 5 is a block diagram illustrating a configuration of a noise suppressing apparatus according to Embodiment 4 of the present invention; and

FIG. 6 is a flow diagram explaining the operations in the noise suppressing apparatus in Embodiment 4 of the present invention.

### BEST MODE FOR CARRYING OUT THE INVENTION

Now, embodiments of the present invention will be described below in detail with reference to accompanying drawings.

### Embodiment 1

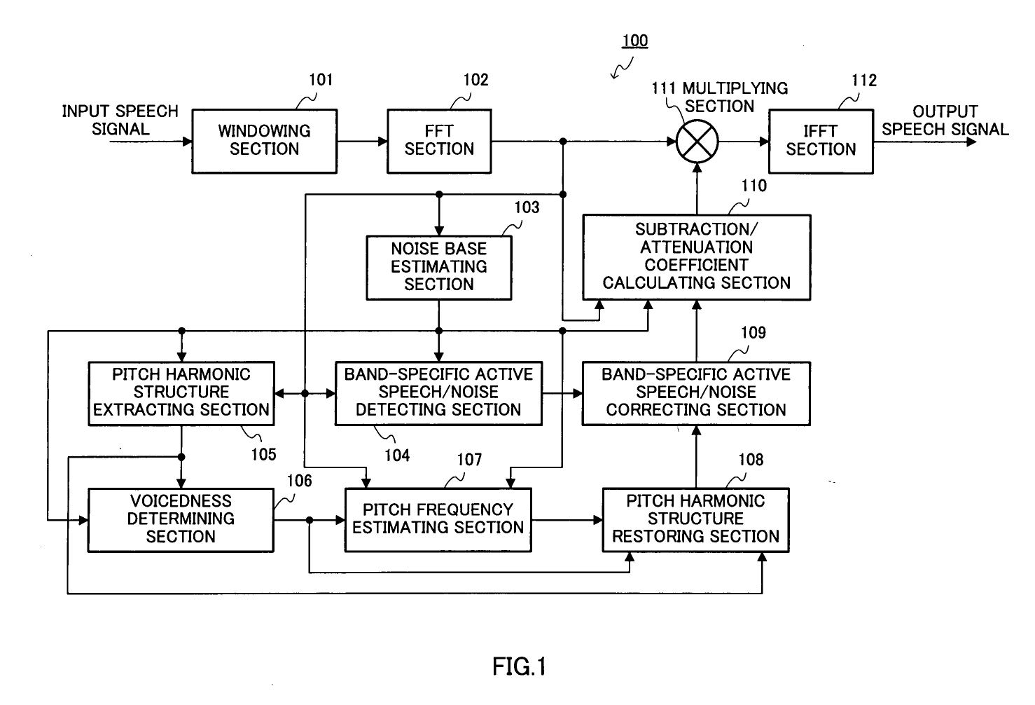

FIG. 1 is a block diagram illustrating a configuration of a noise suppressing apparatus according to Embodiment 1 of the present invention. Noise suppressing apparatus 100 of this Embodiment has windowing section 101; FFT (Fast Fourier Transform) section 102; noise base estimating section 103; band-specific active speech/noise detecting section 104; pitch harmonic structure extracting section 105; voicedness determining section 106; pitch frequency estimating section 107; pitch harmonic structure restoring section 108; band-specific active speech/noise correcting section 109; subtraction/attenuation coefficient calculating section 110; multiplying section 111; and IFFT (Inverse Fast Fourier Transform) section 112.

Windowing section 101 divides an input speech signal containing a noise component on a per frame basis per predetermined time, and performs windowing processing on this frame using, for example, Hanning window, and outputs the result to FFT section 102.

FFT section 102 performs FFT on the frame input from windowing section 101—that is, the speech signal divided on a per frame basis, and transforms the speech signal into a signal in the frequency domain. A speech power spectrum is thus obtained. Accordingly, the speech signal on a per frame basis becomes the speech power spectrum having a predetermined frequency band. The speech power spectrum thus generated from the frame is output to noise base estimating section 103, band-specific active speech/noise detecting section 104, pitch harmonic structure extracting section 105, pitch frequency estimating section 107, subtraction/attenuation coefficient calculating section 110 and multiplying section 111.

Based on the input speech power spectrum, noise base estimating section 103 estimates a frequency amplitude spectrum of a signal containing only a noise component—that is, a noise base. The estimated noise base is output to band-specific active speech/noise detecting section 104, pitch harmonic structure extracting section 105, voicedness determining section 106, pitch frequency estimating section 107 and subtraction/attenuation coefficient calculating section 110.

Further, noise base estimating section 103 compares a speech power spectrum generated from the latest frame from FFT section 102 with a speech power spectrum generated from a frame prior to the latest frame in frequency components of a frequency band of the speech power spectrum. Then, as a result of the comparison, when a difference in power between the two exceeds a preset threshold, noise base estimating section 103 determines that the latest frame contains a speech component, and does not estimate a noise base. Meanwhile, when the difference does not exceed the threshold, noise base estimating section 103 determines that the latest frame does not contain a speech component, and updates the noise base.

Band-specific active speech/noise detecting section 104 detects an active speech band and noise band in the speech power spectrum, based on the speech power spectrum from FFT section 102 and the noise base from noise base estimating section 103. The detection result is output to band-specific active speech/noise correcting section 109.

Based on the speech power spectrum from FFT section 102 and the noise base from noise base estimating section 103, pitch harmonic structure extracting section 105 extracts a pitch harmonic structure, namely, pitch harmonic power spectrum from the speech power spectrum. The extracted pitch harmonic power spectrum is output to voicedness determining section 106 and pitch harmonic structure restoring section 108.

Based on the noise base from noise base estimating section 103 and the pitch harmonic power spectrum from pitch harmonic structure extracting section 105, voicedness determining section 106 determines voicedness of the speech power spectrum. The determination result is output to pitch frequency estimating section 107 and pitch harmonic structure restoring section 108.

Based on the speech power spectrum from FFT section 102 and the noise base from noise base estimating section 103, pitch frequency estimating section 107 estimates a pitch frequency of the speech power spectrum. Further, as the determination result in voicedness determining section 106, when the voicedness of the speech power spectrum is less than or equal to a predetermined level, pitch frequency estimation is not performed. The estimation result is output to pitch harmonic structure restoring section 108.

Based on the pitch harmonic power spectrum from pitch harmonic structure extracting section 105 and the estimation result from pitch frequency estimating section 107, pitch harmonic structure restoring section 108 restores the pitch harmonic structure, namely, pitch harmonic power spectrum. Further, as a result of the determination in voicedness determining section 106, when the voicedness of the speech power spectrum is less than or equal to a predetermined level, pitch harmonic power spectrum restoring is not performed. The restored pitch harmonic power spectrum is output to band-specific active speech/noise correcting section 109.

Band-specific active speech/noise correcting section 109 corrects the detection result based on the pitch harmonic power spectrum selected according to the determination result in the voicedness determining section 106 from the pitch harmonic power spectrum restored by pitch harmonic structure restoring section 108 and the pitch harmonic power spectrum extracted by pitch harmonic structure extracting section 105. For example, as the result of the voicedness determination, when the voicedness of the speech power spectrum is determined to be less than or equal to the predetermined level, the extracted pitch harmonic power spectrum is selected. In this case, the detection result are corrected by combining the pitch harmonic power spectrum from pitch harmonic structure extracting section 105 and the detection result from band-specific active speech/noise detecting section 104. Meanwhile, when the voicedness of the speech power spectrum is determined to be greater than the predetermined level, the restored pitch harmonic power spectrum is selected. In this case, band-specific active speech/noise correcting section 109 corrects the detection results by combining the pitch harmonic power spectrum from pitch harmonic structure restoring section 108 and the detection results from band-specific active speech/noise detecting section 104. The corrected detection result is output to subtraction/attenuation coefficient calculating section 110.

Based on the speech power spectrum from FFT section 102, the noise base from noise base estimating section 103, and the detection result from band-specific active speech/noise correcting section 109, subtraction/attenuation coefficient calculating section 110 calculates a subtraction/attenuation coefficient. The calculated subtraction/attenuation coefficient is output to multiplying section 111.

Multiplying section 111 multiplies the active speech band and noise band in the power speech spectrum from FFT section 102 by the subtraction/attenuation coefficient from subtraction/attenuation coefficient calculating section 110. In this way, the speech power spectrum in which the noise component suppressed is obtained. This multiplication result is output to IFFT section 112.

In other words, a combination of subtraction/attenuation coefficient calculating section 110 and multiplying section 111 constitute a suppressing section that suppresses a noise component in the speech power spectrum, using the detection results of the active speech band and noise band in the speech power spectrum containing the noise component.

IFFT section 112 performs IFFT on the speech power spectrum that is the multiplication result from multiplying section 111. A speech signal is thus generated from the speech power spectrum in which the noise component is suppressed.

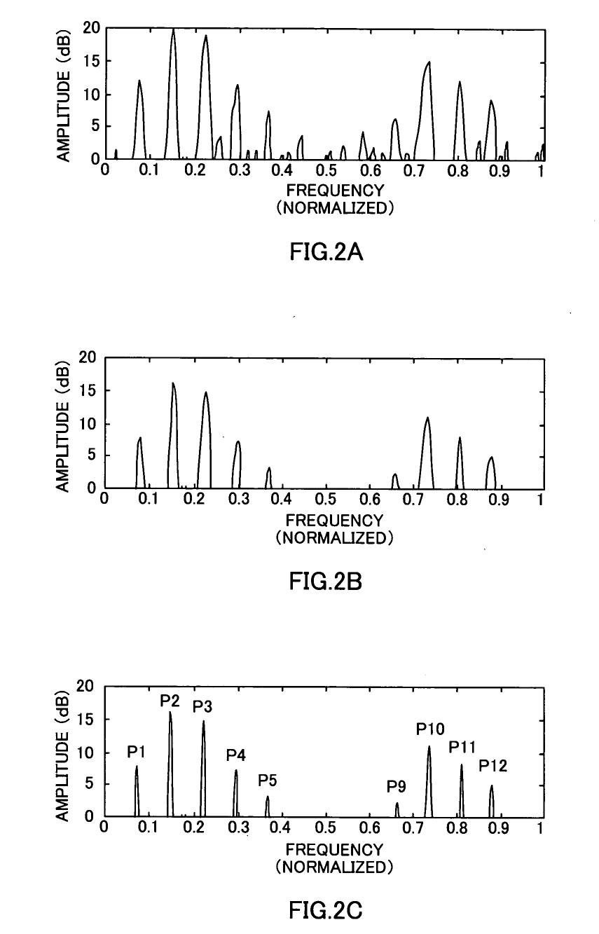

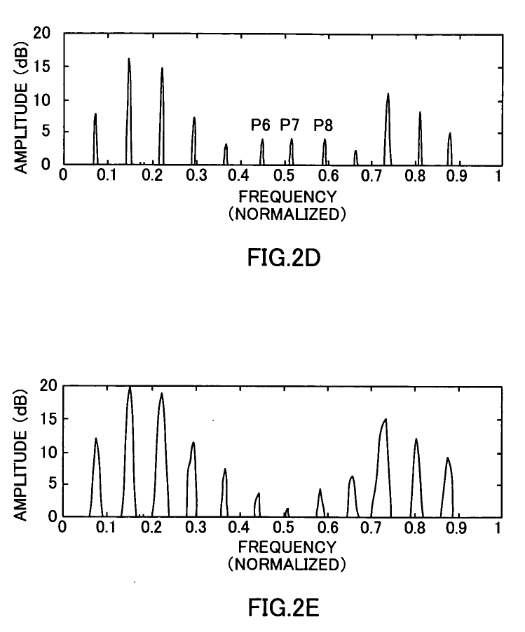

The operations of noise suppressing apparatus 100 having the above-mentioned configuration will be described below. FIGS. 2A to 2E are graphs explaining the operations of correcting the detection result of the active speech band and noise band.

First, FFT section 102 acquires a speech power spectrum S_{F}(k). The speech power spectrum S_{F}(k) is expressed using following Equation (1).

### [Equation 1]

S_{F}(k)={square root over (Re{D_{F}(k)}²+Im{D_{F}(k)}²)}1≦k≦HB/2 (1)

Herein, k indicates a number to specify a frequency component of a frequency band of the speech power spectrum. HB is a transform length of FFT, namely, the number of samples of data to be subjected to fast Fourier transform, and for example, is HB=512. Re{D_{F}(k)} and Im{D_{F}(k)} respectively indicate the real part and imaginary part of the speech power spectrum D_{F}(k) subjected to FFT. In addition, although a square root is used for Equation 1, S_{F}(k) can be calculated without using a square root.

Then, noise base estimating section 103 estimates the noise base N_{B}(n, k) based on the speech power spectrum S_{F}(k), using Equation (2).

### [Equation 2]

$${N}_{B} ( n , k ) = \{ \begin{matrix}{N}_{B} ( n - 1 , k ) & {S}_{F} ( k ) > {Θ}_{B} \cdot {N}_{B} ( n - 1 , k ) \\ ( 1 - α ) \cdot {N}_{B} ( n - 1 , k ) + α \cdot {S}_{F} ( k ) & {S}_{F} ( k ) \leq {Θ}_{B} \cdot {N}_{B} ( n - 1 , k )\end{matrix} \\ 1 \leq k \leq HB / 2 \qquad ( 2 )$$

Here, n indicates a frame number. Further, N_{B}(n−1, k) is an estimation value of the noise base in the previous frame. α is a moving average coefficient of the noise base, and ΘB is a threshold for determining a speech component and noise component.

Then, as shown in FIG. 2A, based on the speech power spectrum S_{F}(k) and the noise base N_{B}(n, k), band-specific active speech/noise detecting section 104 detects active speech bands and noise bands in the speech power spectrum S_{F}(k). Detection results S_{F}(k) of the active speech band and noise band are obtained by performing calculation using the following Equation (3). When a difference obtained by calculation is greater than zero, the band is determined to be a speech band including a speech component. When the difference is less than or equal to zero, the band is determined to be a noise band without a speech component. Here, γ₁ is a constant.

### [Equation 3]

$${S}_{N} ( k ) = \{ \begin{matrix}{S}_{F} ( k ) - {γ}_{1} \cdot {N}_{B} ( n , k ) & {S}_{F} ( k ) > {γ}_{1} \cdot {N}_{B} ( n , k ) \\ 0 & {S}_{F} ( k ) \leq {γ}_{1} \cdot {N}_{B} ( n , k )\end{matrix} \\ 1 \leq k \leq HB / 2 \qquad ( 3 )$$

Then, as shown in FIG. 2B, based on the speech power spectrum S_{F}(k) and the noise base N_{B}(n, k), pitch harmonic structure extracting section 105 extracts the pitch harmonic power spectrum H_{M}(k). The pitch harmonic power spectrum H_{M}(k) is extracted by performing calculation using the following Equation (4). Here, γ₂ is a constant that satisfies γ₂>γ₁.

### [Equation 4]

$${H}_{M} ( k ) = \{ \begin{matrix}{S}_{F} ( k ) - {γ}_{2} \cdot {N}_{B} ( n , k ) & {S}_{F} ( k ) > {γ}_{2} \cdot {N}_{B} ( n , k ) \\ 0 & {S}_{F} ( k ) \leq {γ}_{2} \cdot {N}_{B} ( n , k )\end{matrix} \\ 1 \leq k \leq HB / 2 \qquad ( 4 )$$

Based on the noise base N_{B}(n, k) and the pitch harmonic power spectrum H_{M}(k), voicedness determining section 106 determines the voicedness of the speech power spectrum S_{F}(k). In this Embodiment, assume that, in a frequency band (1˜HB/2) of the speech power spectrum S_{F}(k) a specific frequency band (1˜HP) is a band subjected to voicedness determination. In other words, HP is an upper-limit frequency component in a range of the band subjected to determination.

More preferably, the frequency band (1˜HB/2) is divided into three parts, namely, low-frequency band, middle-frequency band and high-frequency band, and the determination of voicedness is made on the bands as a specific frequency band. Alternately, a configuration may also be adopted where the frequency band (1˜HB/2) are divided into two, namely, low-frequency band and high-frequency band, and the determination of voicedness is made on the bands as a specific frequency band. By thus performing a voicedness determination for the bands obtained by dividing the frequency band, whether or not restoration of the pitch harmonic power spectrum H_{M}(k) is performed can be set separately for a band where the pitch harmonic power spectrum H_{M}(k) is extracted with high quality and a band where the pitch harmonic power spectrum HM(k) is not extracted with high quality.

In addition, when voicedness determining section 106 has a configuration for distinguishing whether the original speech is a consonant or vowel, based on the voicedness determination result per band obtained by dividing the frequency band, whether or not restoration of the pitch harmonic power spectrum H_{M}(k) is performed can be set separately for the constant and vowel.

The voicedness determination of the specific frequency band is made by calculating a ratio between a total value of power of a part corresponding to specific frequencies in the pitch harmonic power spectrum H_{M}(k) and a total value of power of the part corresponding to specific frequencies in the noise base N_{B}(n, k), using following Equation (5). As a result of this determination, when the voicedness of the specific frequency band is higher than a predetermined level, pitch frequency estimation and pitch harmonic structure restoration is performed (described later).

### [Equation 5]

$${V}_{S} = {\sum }_{k = 1}^{HP} {H}_{M} ( k ) / {\sum }_{k}^{HP} {N}_{B} ( n , k ) \qquad ( 5 )$$

Meanwhile, when the voicedness of the specific frequency band is less than or equal to the predetermined level, pitch frequency estimation and pitch harmonic structure restoration is not performed. In this case, based on the extracted pitch harmonic power spectrum H_{M}(k) band-specific active speech/noise correcting section 109 corrects the part corresponding to the specific frequency band among the detection results S_{F}(k) of the active speech band and noise band in the speech power spectrum S_{F}(k). In other words, the part corresponding to the specific frequency band among the detection results S_{F}(k) is not corrected based on the restored pitch harmonic power spectrum H_{M}(k). Therefore, it is possible to selectively use the more accurate pitch harmonic power spectrum H_{M}(k), and remarkably improve the accuracy in detection of the active speech band and noise band.

In addition, in the following descriptions, a case where the voicedness of the specific frequency band is determined to be higher than the predetermined level will be assumed.

Using Equation (6), pitch frequency estimating section 107 multiplies the part corresponding to the specific frequency band in the noise base N_{B}(n, k) by β, and subtracts the result from the part corresponding to the specific frequency band in the speech power spectrum S_{F}(k). Next, using Equation (7), pitch frequency estimating section 107 calculates auto-correlation function R_{P}(m) of the subtraction result Q_{F}(k). Then, m corresponding to the maximum value of the auto-correlation function R_{P}(m) is determined as a pitch frequency.

### [Equation 6 ]

Q_{F}(k)=S_{F}(k)β·N_{B}(m,k)1≦k≦HM (6)

### [Equation 7]

$${R}_{P} ( m ) = {\sum }_{k = 1}^{HM - m} {Q}_{F} ( k ) \cdot {Q}_{F} ( k + m ) \\ 1 \leq m \leq PM \qquad ( 7 )$$

Then, pitch harmonic structure restoring section 108 restores the part corresponding to the specific frequency band in the pitch harmonic power spectrum H_{M}(k) More specifically, restoration is performed according to the procedures as described below when the voicedness of the specific frequency band is determined to be higher than the predetermined level.

First, as shown in FIG. 2C, peaks of the pitch harmonic in the pitch harmonic power spectrum H_{M}(k) (p1 to p5 and p9 to p12) are extracted. In addition, extraction of the peak in the pitch harmonic may be performed only on the specific frequency band.

Secondly, intervals between the extracted peaks are calculated. When the calculated interval exceeds a predetermined threshold (for example, 1.5 times the pitch frequency), as shown in FIG. 2D, peaks that lacks in the pitch harmonic power spectrum H_{M}(k) are inserted based on the estimated pitch frequency m. The pitch harmonic power spectrum H_{M}(k) is thus restored.

Then, as shown in FIG. 2E, in the detection results S_{N}(k), band-specific active speech/noise correcting section 109 regards a part that overlaps with the restored pitch harmonic power spectrum H_{M}(k) as an active speech band, and a part that does not overlap with the restored pitch harmonic power spectrum H_{M}(k) as a noise band. In this way, the detection results S_{N}(k) is corrected.

Next, subtraction/attenuation coefficient calculating section 110 calculates a subtraction/attenuation coefficient G_{C}(k) for each of active speech bands and noise bands in the corrected detection results S_{N}(k), based on the speech power spectrum S_{F}(k) and the noise base N_{B}(n, k). The following Equation (8) is used in calculation. Herein, p is a constant, and g_{c} is a predetermined constant greater than zero and less than 1.

### [Equation 8]

$${G}_{C} ( k ) = \{ \begin{matrix}\vert {S}_{F} ( k ) - μ \cdot {N}_{B} ( n , k ) \vert / {S}_{F} ( k ) & Voiced band \\ {g}_{C} & Noise band\end{matrix} \\ 1 \leq k \leq HB / 2 \qquad ( 8 )$$

Thus, according to this embodiment, since the detection results S_{N}(k) of the active speech band and noise band are corrected based on the pitch harmonic power spectrum H_{M}(k), even when spectral characteristics of the noise component are not stationary, it is possible to accurately detect an active speech band and a noise band. As a result, it is possible to perform subtraction processing with a relatively low degree of attenuation and attenuation processing with a relatively high degree of attenuation respectively on the active speech band and the noise band. By this means, even when the attenuation amount is larger, it is possible to reduce speech distortion and improve accuracy in noise suppression. Further, according to this Embodiment, the detection results S_{N}(k) are corrected based on the pitch harmonic power spectrum selected according to the result of the voicedness determination of the speech power spectrum S_{F}(k) from the extracted pitch harmonic power spectrum H_{M}(k) and the restored pitch harmonic power spectrum H_{M}(k), so that it is possible to further improve the accuracy of the detection results S_{N}(k) and further improve the accuracy in noise suppression.

### Embodiment 2

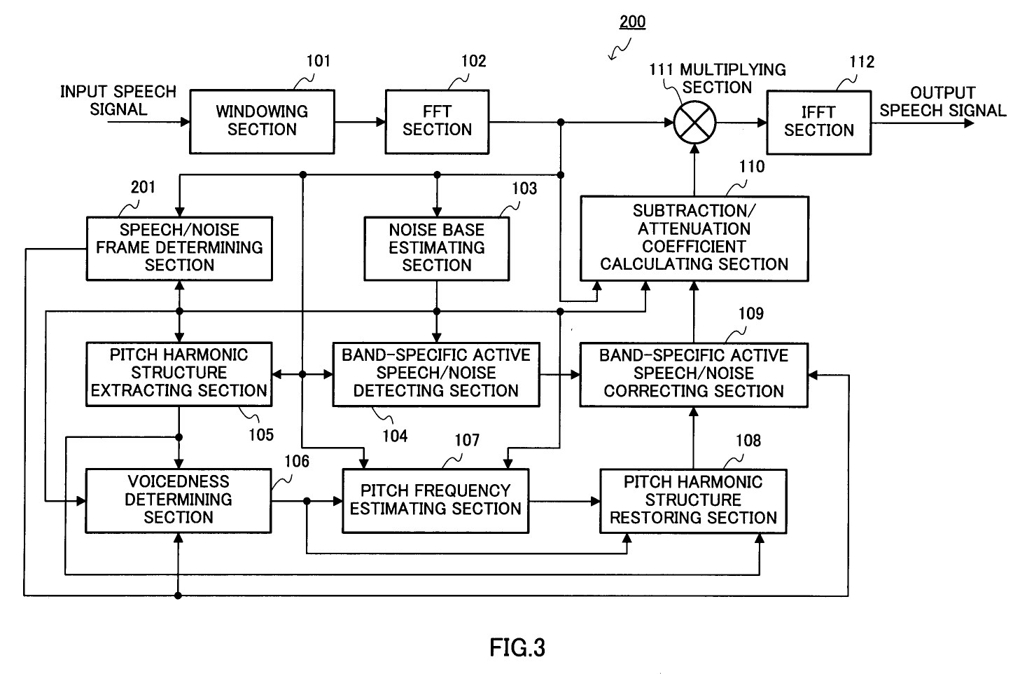

FIG. 3 is a block diagram illustrating a configuration of a noise suppressing apparatus according to Embodiment 2 of the present invention. The noise suppressing apparatus described in this Embodiment has a basic configuration the same as that described in Embodiment 1, and structural components that are the same or corresponding are assigned the same reference codes and their descriptions will be omitted.

Noise suppressing apparatus 200 shown in FIG. 3 has a configuration obtained by adding speech/noise frame determining section 201 to the structural components of noise suppressing apparatus 100 described in Embodiment 1.

Speech/noise frame determining section 201 determines whether a frame from which the speech power spectrum is obtained is a speech frame or a noise frame, based on the speech power spectrum from FFT section 102 and the noise base from noise base estimating section 103. The determination result is output to voicedness determining section 106 and band-specific active speech/noise correcting section 109.

The frame determining operations of speech/noise frame determining section 201 will be described below in detail.

First, speech/noise frame determining section 201 calculates two ratios using following Equations (9) and (10), based on the speech power spectrum S_{F}(k) from FFT section 102 and the noise base N_{B} (n, k) from noise estimating section 103. One of the two ratios is an SNR_{L} that is a ratio between speech power and noise power in a low band in the frequency band of the speech power spectrum S_{F}(k), and the other one is an SNR_{F} that is a ratio between a speech power and noise power in the entire band of the frequency band of the speech power spectrum S_{F}(k). Here, HL is an upper-limit frequency component in the low band, and HF is an upper-limit frequency component in the frequency band of the speech power spectrum S_{F}(k).

### [Equation 9]

$${SNR}_{L} = \{ {\sum }_{k = 1}^{HL} {S}_{F} ( k ) - {β}_{L} \cdot {\sum }_{k = 1}^{HL} {N}_{B} ( n , k ) \} / {\sum }_{k = 1}^{HL} {N}_{B} ( n , k ) \qquad ( 9 )$$

### [Equation 10]

$${SNR}_{F} = \{ {\sum }_{k = 1}^{H F} {S}_{F} ( k ) - {β}_{F} \cdot {\sum }_{k = 1}^{H F} {N}_{B} ( n , k ) \} / {\sum }_{k = 1}^{H F} {N}_{B} ( n , k ) \qquad ( 10 )$$

Then, a correlation value R_{LF}(=SNR_{L}·SNR_{F}) of the two calculated ratios, namely, SNR_{L} and SNR_{F}, and a frame determination is made using following Equation (11). As a result of the frame determination using Equation (11), frame information SNF is generated. The frame information SNF is information indicating whether the frame subjected to determination is a speech frame or noise frame. In Equation (11), M is the number of hangover frames. Further, also when a state having R_{LF} less than or equal to Θ_{SN} does not continue for M consecutive frames, the frame determination result is a speech frame.

### [Equation 11]

$$SNF = \{ \begin{matrix}1 ( Voiced frame ) & {R}_{LF} > {Θ}_{SN} \\ 0 ( Noise frame ) & {R}_{LF} \leq {Θ}_{SN}\end{matrix} \\ for m consecutive frames \qquad ( 11 )$$

When the frame subjected to determination is determined to be a speech frame, the general operations (the operations described in Embodiment 1) is performed in voicedness determining section 106 and band-specific active speech/noise correcting section 109. Meanwhile, when the frame subjected to be determination is determined to be a noise frame, voicedness determining section 106 forcefully determines that the voicedness of the entire band of the frequency band of the speech power spectrum S_{F}(k) generated from the frame subjected to be determination is less than or equal to the predetermined level. As a result, band-specific active speech/noise correcting section 109 corrects the entire band as a noise band.

Thus, according to this Embodiment, when the frame subjected to be determination is determined to be a noise frame, since the voicedness of the entire band of the speech power spectrum S_{F}(k) is determined to be less than or equal to the predetermined level, it is possible to eliminate the processing of correcting the detection results S_{N}(k) that is unnecessary for the noise frame, and reduce the load on the correcting section.

Further, according to this Embodiment, the correlation value R_{LF} is calculated between the power ratio SNR_{L} in the low band of the speech power spectrum S_{F}(k) and the power ratio SNR_{F} of the entire band of the speech power spectrum S_{F}(k), and based on this correlation value R_{LF}, the frame determination is made. It is therefore possible to enhance the power spectrum of a speech component with high correlation between the low band and the entire band, and reduce the power spectrum of a noise component with low correlation. As a result, it is possible to improve the accuracy of frame determination.

### Embodiment 3

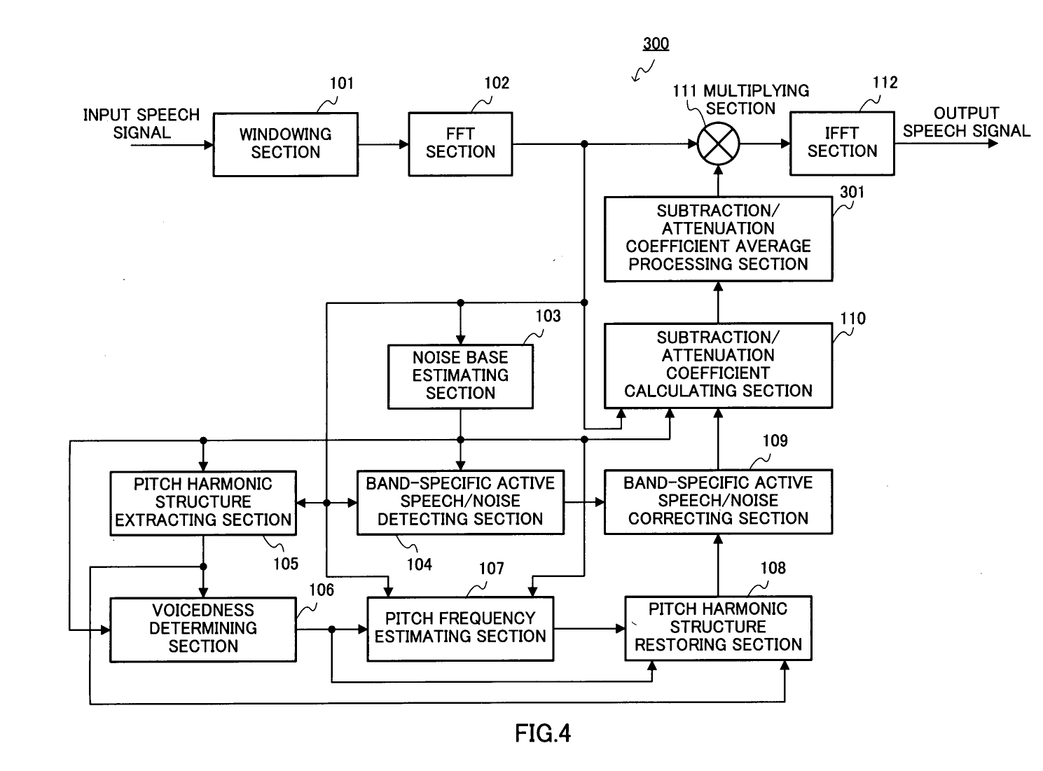

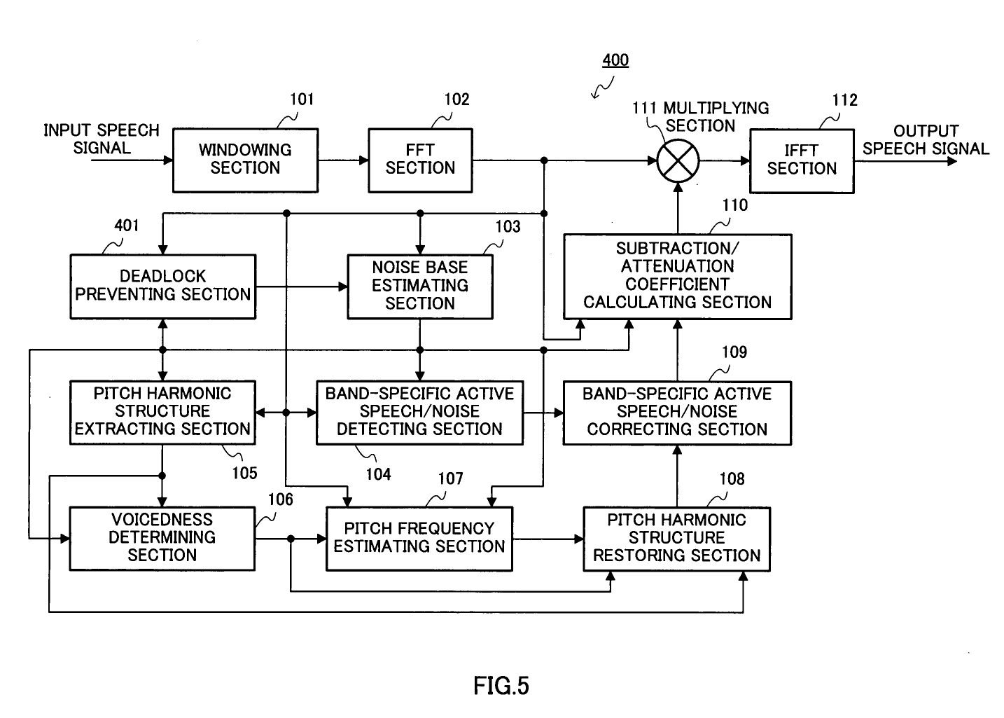

FIG. 4 is a block diagram illustrating a configuration of a noise suppressing apparatus according to Embodiment 3 of the present invention. The noise suppressing apparatus described in this Embodiment has a basic configuration the same as that described in Embodiment 1, and structural components that are the same or corresponding are assigned the same reference codes, and their descriptions will be omitted.

Noise suppressing apparatus 300 shown in FIG. 4 has a configuration obtained by adding subtraction/attenuation coefficient average processing section 301 to the structural components of noise suppressing apparatus 100 described in Embodiment 1. Subtraction/attenuation coefficient average processing section 301 averages the subtraction/attenuation coefficient obtained as the calculation result by subtraction/attenuation coefficient calculating section 110 in the time domain and frequency domain.

The Averaged Subtraction/Attenuation Coefficient is Output to Multiplying Section 111.

In other words, in this Embodiment, a combination of subtraction/attenuation coefficient calculating section 110, subtraction/attenuation coefficient average processing section 301 and multiplying section 111 constitute a suppressing section that suppresses a noise component in the speech power spectrum, using the detection result of the active speech band and noise band in the speech power spectrum containing the noise component.

The coefficient average processing in subtraction/attenuation coefficient average processing section 301 will be described in more detail below.

First, subtraction/attenuation coefficient average processing section 301 averages the subtraction/attenuation coefficient obtained by calculation in subtraction/attenuation coefficient calculating section 110 in the time domain using following Equation (12). Herein, α_{F} and α_{L} are moving average coefficients that satisfy the relationship of α_{F}>α_{L}.

### [Equation 12]

$${\overline{G}}_{T} ( n , k ) = \{ \begin{matrix}( 1 - {α}_{F} ) \cdot {\overline{G}}_{T} ( n - 1 , k ) + {α}_{F} \cdot {G}_{C} ( k ) & {G}_{C} ( k ) > {\overline{G}}_{T} ( n - 1 , k ) \\ ( 1 - {α}_{L} ) \cdot {\overline{G}}_{T} ( n - 1 , k ) + {α}_{L} \cdot {G}_{C} ( k ) & {G}_{C} ( k ) \leq {\overline{G}}_{T} ( n - 1 , k )\end{matrix} \\ 1 \leq k \leq HB / 2 \qquad ( 12 )$$

Further, using the following Equation (13), subtraction/attenuation coefficient average processing section 301 averages the subtraction/attenuation coefficient in the frequency domain. Here, K_{H}-K_{L} is the number of frequency components as a range subjected to averaging.

### [Equation 13]

$${\overline{G}}_{F} ( k ) = \frac{1}{{K}_{H} - {K}_{L}} {\sum }_{i = k - {K}_{L}}^{k + {K}_{H}} {\overline{G}}_{T} ( n , i ) \\ 1 \leq k \leq HB / 2 \qquad ( 13 )$$

Then, the subtraction/attenuation coefficient subjected to the time average processing using Equation (12) and the subtraction/attenuation coefficient subjected to the frequency average processing using Equation (13) are compared. Then, according to a relation between these values, the subtraction/attenuation coefficient used in multiplying section 111 is selected. For example, as shown in the following Equation (14), when the subtraction/attenuation coefficient subjected to the time average processing is greater than the subtraction/attenuation coefficient subjected to the frequency average processing, the subtraction/attenuation coefficient subjected to the time average processing is selected, and, when the subtraction/attenuation coefficient subjected to the time average processing is not greater than the subtraction/attenuation coefficient subjected to the frequency average processing, the subtraction/attenuation coefficient subjected to the frequency average processing is selected.

### [Equation 14]

$${\overline{G}}_{C} ( k ) = \{ \begin{matrix}{\overline{G}}_{T} ( n , k ) & {\overline{G}}_{T} ( n , k ) > {\overline{G}}_{F} ( k ) \\ {\overline{G}}_{F} ( k ) & {\overline{G}}_{T} ( n , k ) \leq {\overline{G}}_{F} ( k )\end{matrix} \\ 1 \leq k \leq HB / 2 \qquad ( 14 )$$

Thus, according to this Embodiment, since the time average processing is performed on the subtraction/attenuation coefficient used in noise suppression, it is possible to improve discontinuity of speech due to a rapid change in subtraction/attenuation coefficient on the time axis, and reduce the speech distortion due to a variation of remaining noise.

Further, according to this Embodiment, since the frequency average processing is performed on the subtraction/attenuation coefficient, it is possible to improve discontinuity of an attenuation amount on the frequency axis, and reduce the speech distortion even when the noise attenuation amount is increased.

In addition, subtraction/attenuation coefficient average processing section 301 explained in this Embodiment can be used also in noise suppressing apparatus 200 explained in Embodiment 2.

### Embodiment 4

FIG. 5 is a block diagram illustrating a configuration of a noise suppressing apparatus according to Embodiment 4 of the present invention. The noise suppressing apparatus described in this Embodiment has a basic configuration the same as that described in Embodiment 1, and structural components that are the same or corresponding are assigned the same reference codes and their descriptions will be omitted.

Noise suppressing apparatus 400 shown in FIG. 5 has a configuration obtained by adding deadlock preventing section 401 to the structural components of noise suppressing apparatus 100 described in Embodiment 1.

Noise base estimating section 103 of noise suppressing apparatus 400 performs the operations as explained in Embodiment 1, and, in addition, stops update of the noise base—that is, causes a deadlock state—when a level of a noise component sharply changes.

Deadlock preventing section 401 has a counter. The counter is provided in association with a frequency component in the frequency band of the speech power spectrum, and counts the number of times the power of the corresponding frequency component in the noise base estimated in noise base estimating section 103 is consecutively greater than or equal to a predetermined value. Based on the counted number of times, deadlock preventing section 401 prevents stopping update of the noise base in noise base estimating section 103, namely, the so-called deadlock state.

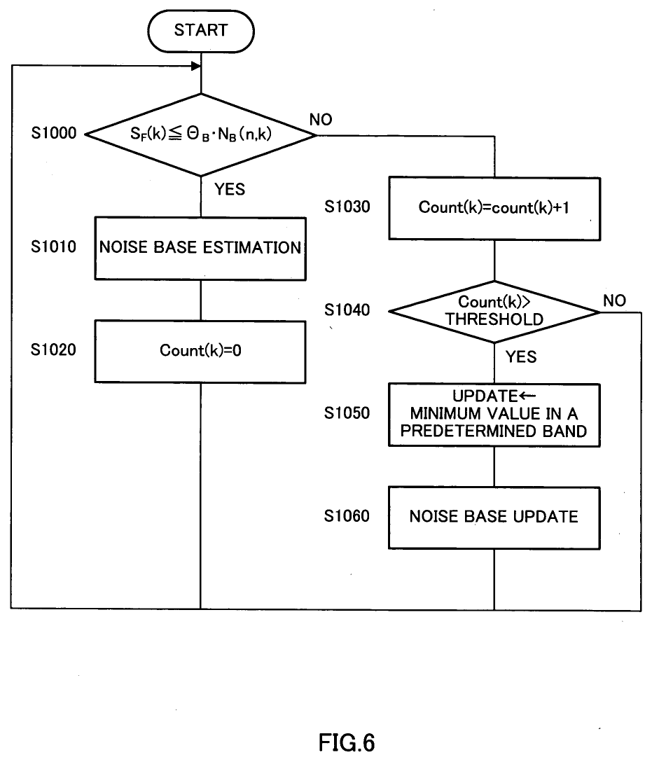

The operations of preventing the deadlock state in noise suppressing apparatus 400 will be described in more detail below using FIG. 6.

First, in step ST1000, deadlock preventing section 401 determines whether or not the speech power spectrum S_{F}(k) is less than or equal to Θ_{B} times of the noise base N_{B}(n, k). As a result of the determination, when the speech power spectrum S_{F}(k) is less than or equal to Θ_{B} times of the noise base N_{B}(n, k) (S1000:YES), noise base estimating section 103 performs usual noise base estimation (S1010). Then, in step S1020, the count (k) counted in the counter provided in deadlock preventing section 401 is reset to zero. Then, the processing flow returns to step S1000.

Meanwhile, as a result of the determination in step S1000, when the speech power spectrum S_{F}(k) is greater than Θ_{B} times of the noise base N_{B}(n, k) (S1000:NO), the counter counts up the count(k) (S1030). Then, in step ST1040, deadlock preventing section 401 compares the count (k) with a predetermined threshold. As a result of the comparison, when the count (k) is greater than the predetermined threshold (S1040: YES), deadlock preventing section 401 sets the minimum value of the noise power spectrum in a predetermined band containing the corresponding frequency component k as an update value of the noise base N_{B}(n, k) (S1050), and updates the noise base N_{B}(n, k) using this update value (S1060). Then, the processing flow returns to step S1000. Meanwhile, as a result of the comparison in step S1040, when the count (k) is less than or equal to the predetermined threshold (S1040: NO), the processing flow directly returns to step S1000.

Thus, when the power in the speech power spectrum S_{F}(k) is greater than or equal to a predetermined value a predetermined number of times consecutively, the noise base N_{B}(n, k) can be updated with the minimum value of power of the noise power spectrum in a predetermined band containing the corresponding frequency component k, thereby preventing the deadlock state irrespective of the speech segment or noise segment. The above-mentioned predetermined band is preferably set between peaks in the pitch harmonic. By this means, it is possible to detect a valley of the noise power spectrum and easily detect the minimum value of the noise power spectrum that is an update value.

In addition, deadlock preventing section 401 explained in this Embodiment can be used in noise suppressing apparatuses 200 and 300, respectively, explained in Embodiments 2 and 3.

Further, the present invention is able to adopt various embodiments, and is not limited to above-mentioned Embodiments 1 to 4. For example, the above-mentioned noise suppressing method may be executed as software by a computer. In other words, by storing a program for executing the noise suppressing method described in the above-mentioned Embodiments beforehand in a storage medium such as ROM (Read Only Memory), and operating the program by a CPU (Central Processor Unit) it is possible to implement the noise suppressing method of the present invention.

In addition, each of functional blocks employed in the description of the above-mentioned embodiment may typically be implemented as an LSI constituted by an integrated circuit. These are may be individual chips or partially or totally contained on a single chip.

“LSI” is adopted here but this may also be referred to as an “IC”, “system LSI”, “super LSI”, or “ultra LSI” depending on differing extents of integration.

Further, the method of integrating circuits is not limited to the LSI's, and implementation using dedicated circuitry or general purpose processor is also possible. After LSI manufacture, utilization of FPGA (Field Programmable Gate Array) or a reconfigurable processor where connections or settings of circuit cells within an LSI can be reconfigured is also possible.

Furthermore, if integrated circuit technology comes out to replace LSI's as a result of the advancement of semiconductor technology or derivative other technology, it is naturally also possible to carry out function block integration using this technology. Application in biotechnology is also possible.

The present application is based on Japanese Patent Application No. 2004-181454 filed on Jun. 18, 2004, the entire content of which is expressly incorporated by reference herein.

### INDUSTRIAL APPLICABILITY

The noise suppressing apparatus and noise suppressing method of the present invention have the effect of reducing speech distortion and improving accuracy in noise suppression, and are applicable to, for example, a speech communication apparatus and speech recognition apparatus.

1. A noise suppressing apparatus comprising:
a suppressing section that suppresses a noise component in a speech power spectrum using a detection result of an active speech band and noise band in the speech power spectrum containing the noise component;
an extracting section that extracts a pitch harmonic power spectrum from the speech power spectrum;
a voicedness determination section that determines a voicedness of the speech power spectrum based on the extracted pitch harmonic power spectrum;
a restoration section that restores the extracted pitch harmonic power spectrum; and
a correcting section that corrects the detection result based on the pitch harmonic power spectrum selected from the restored pitch harmonic power spectrum and the extracted pitch harmonic power spectrum, according to the determination result by the voicedness determination section.

2. The noise suppressing apparatus according to claim 1, wherein:
the speech power spectrum has a predetermined frequency band;
the voicedness determination section determines the voicedness of a specific band in the predetermined frequency band; and
the correcting section corrects apart corresponding to the specific band among the detection result based on the restored pitch harmonic power spectrum when the voicedness of the specific band is greater than or equal to a predetermined level as a result of the determination by the voicedness determination section, and corrects the part based on the extracted pitch harmonic power spectrum when the voicedness of the specific band is less than the predetermined level.

3. The noise suppressing apparatus according to claim 2, further comprising a noise base estimation section that estimates a noise base from the speech power spectrum, wherein the voicedness determination section determines voicedness of the specific band based on a ratio between a total value of power of the part corresponding to the specific band in the extracted pitch harmonic power spectrum and a total value of power of the part corresponding to the specific band in the estimated noise base.

4. The noise suppressing apparatus according to claim 2, wherein:
the speech power spectrum is obtained from an input frame;
the noise suppressing apparatus further comprises a frame determination section that determines whether the frame is a speech frame or a noise frame; and
the voicedness determination section that determines that the voicedness of the entire band of the predetermined frequency band is less than or equal to the predetermined level when the frame is determined to be a noise frame as a result of the determination by the frame determination section.

5. The noise suppressing apparatus according to claim 2, wherein the suppressing section has a time average processor that averages a coefficient obtained from the detection result in the time domain, and a multiplier that multiplies the averaged coefficient by the speech power spectrum.

6. The noise suppressing apparatus according to claim 2, wherein the suppressing section has a frequency average processor that averages a coefficient obtained from the detection result in the frequency domain, and a multiplier that multiplies the averaged coefficient by the speech power spectrum.

7. The noise suppressing apparatus according to claim 2, further comprising:
an update stopping section that stops update of the noise base; and
a preventing section that prevents stopping update of the noise base of the update stopping section when power of a frequency component in the predetermined frequency band of the speech power spectrum is greater than or equal to a predetermined value a predetermined number of times consecutively.

8. A noise suppressing method of suppressing a noise component in a speech power spectrum using the detection result of an active speech band and noise band in the speech power spectrum containing the noise component, comprising:
an extracting step of extracting a pitch harmonic power spectrum from the speech power spectrum;
a voicedness determining step of determining a voicedness of the speech power spectrum based on the extracted pitch harmonic power spectrum;
a restoring step of restoring the extracted pitch harmonic power spectrum; and
a correcting step of correcting the detection results based on the pitch harmonic power spectrum selected from the restored pitch harmonic power spectrum and the extracted pitch harmonic power spectrum, according to the determination result in the voicedness determining step.

9. A noise suppressing program for suppressing a noise component in a speech power spectrum using a detection result of an active speech band and noise band in the speech power spectrum containing the noise component, the noise suppressing program allowing a computer to implement:
an extracting step of extracting a pitch harmonic power spectrum from the speech power spectrum;
a voicedness determining step of determining a voicedness of the speech power spectrum based on the extracted pitch harmonic power spectrum;
a restoring step of restoring the extracted pitch harmonic power spectrum; and
a correcting step of correcting the detection result based on the pitch harmonic power spectrum selected from the restore-d pitch harmonic power spectrum and the extracted pitch harmonic power spectrum, according to the determination result in the voicedness determining step.
